(19) United States
(12) Patent Application Publication
(10) Pub. No.: US 2023/0212384 A1
(43) Pub. Date: Jul. 6, 2023

(54) HIGH-TEMPERATURE-RESISTANT INSULATING COATING MATERIAL AND PREPARATION METHOD THEREOF

(71) Applicant: SHENZHEN INSTITUTES OF ADVANCED TECHNOLOGY CHINESE ACADEMY OF SCIENCES, Shenzhen (CN)

(72) Inventors: Suibin LUO, Shenzhen (CN); Panpan RUAN, Shenzhen (CN); Pengpeng XU, Shenzhen (CN); Rong SUN, Shenzhen (CN); Shuhui YU, Shenzhen (CN)

(73) Assignee: SHENZHEN INSTITUTES OF ADVANCED TECHNOLOGY CHINESE ACADEMY OF SCIENCES, Shenzhen (CN)

(21) Appl. No.: 17/641,822

(22) PCT Filed: Sep. 10, 2019
(86) PCT No.: PCT/CN2019/105194

§ 371 Date: Mar. 10, 2022

(51) Int. Cl. C08L 63/00; C08G 59/24; C08G 59/28; C08G 59/40; C08G 59/50; C08K 3/22

(52) U.S. Cl. CPC C08L 63/00; C08G 59/245; C08G 59/28; C08G 59/4021; C08G 59/5073; C08K 3/22; C08K 2201/005; C08K 2201/011; C08L 2201/08; C08L 2203/206; C08K 2003/2227; C08L 2203/16

(57) ABSTRACT

A high-temperature-resistant insulating polymer composite is provided, including the following components in parts by mass: 3-12 parts of cyanate ester resin, 3-20 parts of epoxy resin, 5-15 parts of an inorganic filler, 0.1-2 parts of an epoxy resin curing agent, 0.0001-0.005 parts of a curing accelerant, and 0.1-2 parts of a dispersant. A glass transition temperature of the cured high-temperature-resistant insulating polymer composite is higher than 120° C.

### CROSS REFERENCE TO THE RELATED APPLICATIONS

This application is the national phase entry of International Application No. PCT/CN2019/105194, filed on Sep. 10, 2019, the entire contents of which are incorporated herein by reference.

### TECHNICAL FIELD

The present invention belongs to the technical field of electronic packaging materials, and more particularly relates to an insulating coating material applied to system-level package of a semiconductor.

### BACKGROUND

Along with development of electronic information technology, in particular, rapid development of wearable electronics, smart phones, ultrathin computers, manless driving, Internet of things technology and 5G communication technology in recent years, higher and higher demands on miniaturization, lightweight, multifunction, high performance and the like of an electronic system are put forward. An encapsulated carrier plate/substrate/circuit board and a chip are adjacent to a PCB, thereby playing a circuit carrying role. Heat generated in an operating process of an electronic device will be gathered in the encapsulated carrier plate/substrate/circuit board to generate high temperature. Thus, it is requires that a raw material for producing the encapsulated carrier plate/substrate/circuit board is good in heat resistance.

Generally speaking, as the temperature raises, dielectric constant, dielectric loss and dielectric loss of the material will be increased. High dielectric constant and dielectric loss will delay high-frequency and high-speed transmission of electrical signals, thereby, the product performance is affected. After the coefficient of thermal expansion is increased, phenomena such as layering and warping between the material and a copper wire happen easily, so that the reliability of the product is affected.

In order to overcome heat resistance of the material, it is required that the material has a higher glass transition temperature. An epoxy resin-based composite material with good processability has been widely applied to the encapsulated carrier plate/substrate/circuit board. A method of raising the glass transition temperature of the epoxy resin composite material is primarily to improve the proportion of rigid groups such as benzene rings in molecular chains of an epoxy condensate. However, as the content of the benzene rings is increased, the rigidity of the epoxy condensate will be improved. In a using process, the material is like to have the reliability problems such as cracking and warping.

In order to solve the above-mentioned problems, the present invention provides a high-temperature-resistant insulating coating material usable for semiconductor package and suitable for an addition process or a semi-addition process.

### SUMMARY

In order to overcome defects in the prior art, the present invention provides a high-temperature-resistant insulating coating material usable for semiconductor package and suitable for an addition process or a semi-addition process to prepare fine circuit.

In order to achieve the objective, the present invention adopts a technical scheme below.

On the one hand, the present invention provides a high-temperature-resistant insulating polymer composite, including a cyanate ester resin, an epoxy resin, an inorganic filler, an epoxy resin curing agent, a curing accelerant and a dispersant.

In the technical scheme of the present invention, the high-temperature-resistant insulating polymer composite is prepared from the following components in parts by mass:

3-12 parts of cyanate ester resin, 3-20 parts of epoxy resin, 5-15 parts of inorganic filler, 0.1-2 parts of epoxy resin curing agent, 0.0001-0.005 parts of curing accelerant and 0.1-2 parts of dispersant,

preferably, 5-8 parts of cyanate ester resin, 5-17 parts of epoxy resin, 8-12 parts of inorganic filler, 0.4-1 part of epoxy resin curing agent, 0.001-0.003 parts of curing accelerant and 0.1-0.5 parts of dispersant.

In the technical scheme of the present invention, the mass of the cyanate ester resin accounts for 5-85% of the total mass of the cyanate ester resin and the epoxy resin, preferably 10-65% and more preferably 15-45%.

When the content of cyanate ester resin is less than 5 wt %, the glass transition temperature of the cured insulating polymer composite is not prone to reaching over 120° C. When the content of cyanate ester resin is higher than 85%, the flexibility of the cured insulating polymer composite is poor.

In the technical scheme of the present invention, a glass transition temperature of the high-temperature-resistant insulating polymer composite is higher than 120° C., preferably higher than 140° C. and more preferably higher than 160° C.

In the technical scheme of the present invention, the high-temperature-resistant insulating polymer composite is a laminate with a thickness of 1 μm to 300 μm, preferably with a thickness of 10 μm to 150 μm, and more preferably with a thickness of 15 μm to 100 μm.

In the technical scheme of the present invention, the cyanate ester resin is selected from one or more of bisphenol A cyanate ester, bisphenol F cyanate ester, bisphenol E cyanate ester, bisphenol M cyanate ester, dicyclopentadiene cyanate ester, phenolic cyanate ester and tetramethyl bisphenol F cyanate ester.

In the technical scheme of the present invention, the epoxy resin is selected from one or more of bisphenol A epoxy resin, for example, NPEL-128, NPEL-127, NPEL-144, NPES-609, NPES-901, NPES-902,NPES-903, NPES-904, NPES-907 and NPES-909 produced by Nanya, KUKDO YD-001, YD-012,YD-013k, YD-014, YD-134, YD-134D, YD-134L, YD-136, YD-128 and YD-127, Araldite® GY 2600, Araldite® GY 6010, Araldite® GY 6020, Araldite® MY 790-1, Araldite® LY 1556 and Araldite® GY 507 produced by PHOBOL and the like; bisphenol F epoxy resin, for example, NPEF-170 produced by Nanya, EPALLOY 8220, EPALLOY 8220E and EPALLOY 8230 produced by CVC, Araldite® GY 281, Araldite® GY 282, Araldite® GY 285, Araldite® PY 306, Araldite® PY 302-2 and Araldite® PY 313 produced by PHOBOL and the like; phenolic epoxy resin, for example, NPPN-638S and NPPN-631 produced by Nanya, EPALLOY 8240, EPALLOY 8240, EPALLOY 8250 and EPALLOY 8330 produced by Nanya, EPALLOY 8240, EPALLOY 8240, EPALLOY 8250, EPALLOY 8330 produced by CVC and the like; o-methyl phenolic epoxy resin, for example, NPCN-701, NPCN-702, NPCN-703, NPCN-704, NPCN-704L and NPCN-704K80 produced by Nanya and the like; multifunctional epoxy resin, for example, NPPN-431A70 produced by Nanya, ERISYS GA-240 produced by CVC and the like; alicyclic epoxy resin, for example, EPALLOY 5000, EPALLOY 5200 and JE-8421 produced by CVC and the like; resorcinol epoxy resin, for example, ERISYS RDGE produced by CVC and the like; rubber modified epoxy resin, for example, HyPox RA 95, HyPox RA 840, HyPox RA1340, HyPox RF 928, HyPox RM 20, HyPox RM 22, HyPox RK 84L and HyPox RK 820 produced by CVC and the like; polyurethane modified epoxy resin and biphenyl epoxy resin, for example, YX4000, YX4000K, YX4000H, YX4000HK, YL6121H, YL6121HN and dicyclopentadiene epoxy resin produced by Mitsui Chemicals; bromated epoxy resin, for example, CYDB-500, CYDB-700, CYDB-900, CYDB-400 and CYDB-450A80 produced by Yueyang Baling Petrochemical Corp and the like.

In the technical scheme of the present invention, the epoxy resin curing agent is selected from one or more of a fatty polyamine curing agent, for example, ethanediamine, diethylenetriamine, triethylene tetramine, tetraethylenepentamine, diethylenetriamine, dimethylaminopropylamine, diethylaminepropylamine, trimethylhexamethylenediamine, dihexyltriamine, trimethylhexanediamine, polyethenoxyamine and the like; an alicyclic polyamine curing agent, for example, diaminomethylcyclohexane, menthane diamine, aminoethyl piperazine, hexahydropyridine, diaminocyclohexane, diaminomethylcyclohexyl methane, diaminocyclohexyl methane and the like; an aromatic amine curing agent, for example, m-phenylenediamine, m-xylylenediamine, diaminodiphenyl-methane, bicyclofluorenediamine, diaminodiphenyl sulfone, 4-chloro-o-phenylenediamine; an anhydride curing agent, for example, benzophenone tetracarboxylic anhydride, methyl endomethyltetrahydrophthalic anhydride, tetrahydrophthalic anhydride, methyltetrahydrophthalic anhydride, glutaric anhydride, polyazelaic polyanhydride, dichloromaleic anhydride, methylhexahydrophthalic anhydride, phthalic anhydride, trimellitic anhydride, pyromellitic dianhydride, terephthalic dianhydride, diphenylketone tetracarboxylic dianhydride, maleic anhydride, dodecyl maleic anhydride, succinic anhydride, hexahydrophthalic anhydride, cyclopentane tetracarboxylic acid dianhydride, cis-dibutenedioic maleic anhydride methyl ethyl benzene and the like; a polyamide curing agent; a latent curing agent, for example, cyanoguanidine, boron trifluoride monoethylamine, boron trifluoride phenylethylamine, boron trifluoride o-toluidine, boron trifluoride bianamine, boron trifluoride dimethylaniline, boron trifluoride ethylaniline, boron trifluoride pyridine, an MS-1 microcapsule, an MS-2 microcapsule and triacylhydrazine maleate; and a synthetic resin curing agent, for example, aniline formaldehyde resin, phenol-formaldehyde resin, linear phenolic resin and the like.

In the technical scheme of the present invention, the epoxy resin curing accelerant is selected froman imidazole epoxy resin curing accelerant, for example, 2-methylimidazole, 2-methyl-4-ethylimidazole, 2-ethylimidazole, 2,4-diethylimidazole, 2-ethyl-4-methylimidazole, 2-hendecylimidazole, 2-heptadecylimidazole and the like; and one or more of phenol, bisphenol A, resorcinol, 2,4,6-tri(dimethyl amino methylene) phenol, benzyl dimethylamine, acyl guanidine, benzoyl peroxide, copper acetylacetone, aluminum acetylacetone, zirconium acetylacetone and the like.

In the technical scheme of the present invention, the inorganic filler is selected from one of or a mixture of more of silicon dioxide, aluminum oxide, boron nitride, titanium dioxide, zinc oxide, zirconium oxide, magnesium oxide, calcium carbonate, barium titanate, strontium titanate, barium strontium titanate, lead zirconate titanate and calcium copper titanate and the like.

In the technical scheme of the present invention, dimensions of inorganic filler particles are 20 nm-10 μm, more preferably 50 nm-3 μm and more preferably 200 nm-1 μm or the inorganic filler particles are a multi-scale mixture.

In the technical scheme of the present invention, the inorganic filler particles are spherical, spheroidal, rodlike, linear and flaky particles and the like.

In the technical scheme of the present invention, the inorganic filler particles account for 20-80% by mass of solid components of the composite, preferably 30-60% and more preferably 45-55%, said solid components of the composite is the components without volatile components such as solvents and the like.

The dispersant used in the present invention is a non-ionic emulsifier, the non-ionic emulsifier is selected one or more from the group consisting of, for example, nonylphenol polyoxyethylene ether, alkyl phenol polyoxyethylene ether, high-carbon fatty alcohol polyoxyethylene ether, fatty acid polyoxyethylene ether, fatty acid methyl ester ethoxylate and a high-molecular polymer and the like; an anionic emulsifier such as cis-9-sodium octadecenoate, sodium oleate, sodium oleate, sodium laurate, C13-C18 sodium alkyl benzene sulfinate and sulfate; and a cationic emulsifier, for example, an alkyl ammonium salt such as dodecyl ammonium chloride, a quaternary ammonium salt such as cetyl trimethyl ammonium bromide and cetyl brominated pyridine pyran.

In the technical scheme of the present invention, when the insulating coating polymer composite is prepared the, all the raw materials are mixed with a solvent to prepare the electronic slurry, wherein the solvent used is a volatile solvent, preferably selected from an aromatic solvent such as xylene, o-xylene, m-xylene, p-xylene, hexamethyl benzene and ethylbenzene; a halogenated hydrocarbon solvent such as chlorobenzene, dichlorobenzene and dichloromethane; a fatty hydrocarbon solvent such as pentane, pentane and pentane; the solvent used is an alicyclic hydrocarbon solvent such as cyclohexane, cyclohexanone, toluene cyclohexanone and the like; t an alcohol solvent such as methanol, ethanol, isopropanol and the like; an ester solvent such as methyl acetate, acetic ether, propyl acetate and the like; a ketone solvent such as acetone, 2-butanone and methyl isobutyl ketone; and an amide solvent such as dimethylformamide, hexamethyl phosphamide, N-methyl formamide and dimethylacetamide.

The glass transition temperature of the cured insulating polymer composite is higher than 120° C. If the glass transition temperature of the condensate is lower than 120° C., an electronic apparatus prepared by using the material is prone to failure in the using process, which goes against long-term stable work of the apparatus.

In the technical scheme of the present invention, the insulating polymer composite further includes an auxiliary agent, wherein preferably, the auxiliary agent is selected one or more from the group consisting of a dispersant, a defoamer, a coupling agent, an anti-settling agent, a leveling agent, a rheological agent and a flame retardant.

On the other hand, the present invention provides a preparation method of the insulating polymer composite, including: dispersing the components uniformly by dispersing means of stirring, ball milling, sanding and ultrasonic treatment and the like to form electronic slurry of the insulating polymer composite; and forming a thin film on a substrate by the electronic slurry of the insulating polymer composite.

On the other hand, the present invention provides the use of the insulating polymer composite in the preparation of a high-temperature-resistant insulating coating material.

On yet another hand, the present invention provides a high-temperature-resistant insulating coating material, being a three-layered structure composed of a protective film layer, a layer of the insulating polymer composite and a film material layer, wherein the layer of the high-temperature-resistant insulating polymer composite is supported by the film material layer, and a surface of the layer of the insulating polymer composite is covered with the protective film.

In the technical scheme of the present invention, the film material layer is selected from a polymer film material or a paper-based film material, preferably, a polyester (PET) film, a polyether-ether-ketone (PEEK) film, a polyetherimide (PEI) film, a polyimide (PI) film, a polycarbonate (PC) film, release paper, coated paper and the like.

In the technical scheme of the present invention, the thickness of the film material layer is 10 μm-300 μm, preferably 20 μm-100 μm and most preferably 30 μm-60 μm.

In the technical scheme of the present invention, the electronic slurry of the insulating polymer composite can form a uniform and smooth thin film on the surface of a supporting film material.

In the technical scheme of the present invention, the protective film layer is selected from a polymer thin film material, a polyester film (PET), a polypropylene film (OPP), a polyethylene film (PE), and the like.

In the technical scheme of the present invention, the thickness of the protective film material is 10 μm-300 μm, preferably 20 μm-100 μm and most preferably 30 μm-60 μm. The thickness of the insulating polymer composite between the film material layer, and the protective film layer is 1 μm-100 μm, preferably 10 μm-50 μm and more preferably 15 μm-30 μm.

On the other hand, the present invention provides a preparation method of the high-temperature-resistant insulating coating material, including: 1) uniformly dispersing cyanate ester resin, epoxy resin, inorganic filler, aepoxy resin curing agent, curing accelerant, dispersant and solvent to form electronic slurry of insulating polymer composite; and

2) coating the electronic slurry of insulating polymer composite to a surface of film material layer, attaching the electronic slurry of insulating polymer composite to a protective film layer after being dried by an oven to form the insulating coating material.

In the technical scheme of the present invention, the coating mode of the electronic slurry of the insulating polymer composite is selected from gravure printing, micro-gravure printing, comma scrapers, slit extrusion and the like, and the drying temperature of the solvent is 50° C.-150° C., and more preferably, drying is the sectional temperature rise baking.

In the technical scheme of the present invention, after the solvent is baked and dried, attaching the protective film and obtaining the insulating coating material with a three-layered structure in a hot-pressing mode, and more preferably, a hot-pressing temperature is 50-100° C.

Optionally, in a process of preparing the electronic slurry of the insulating polymer composite, an auxiliary agent is further added to mix, wherein the auxiliary agent is selected from a defoamer, a coupling agent, an anti-settling agent, a leveling agent, a rheological agent and a flame retardant.

On yet another hand, the present invention provides the use of the high-temperature-resistant insulating coating material for semiconductor electronic package of a printed circuit board (PCB), a substrate and a carrier board, preferably, the semiconductor electronic package being fine circuit package.

### BRIEF DESCRIPTION OF THE DRAWINGS

FIG. 1 is a schematic structural diagram of an insulating coating material, wherein 1-1 is a protective film layer, 1-2 is a layer of the insulating polymer composite, and 1-3 is a supporting film material layer.

FIG. 2 is a schematic structural diagram of an insulating polymer composite in the insulating coating material, wherein 2-1 are inorganic filler particles and 2-2 is a high molecular polymer.

FIG. 3 is a schematic flow diagram of the insulating coating material prepared by the present invention.

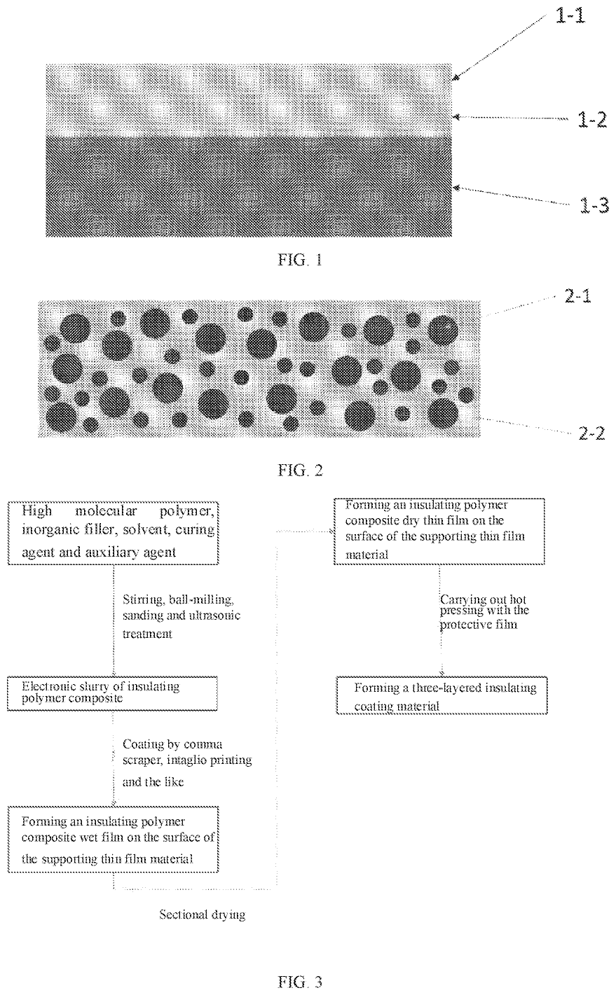

### DETAILED DESCRIPTION OF THE EMBODIMENTS

In order to make purposes, features and advantages of the present invention more obvious and understandable, detailed description on specific embodiments of the present invention will be made below in combination with the drawings, but cannot be understood as limitation to the applicable scope of the present invention.

The embodiment provides a high-temperature-resistant insulating coating material usable for semiconductor package and suitable for an addition process or a semi-addition process of fine circuit, the material being prepared by the following steps:

### Example 1

1. The components are weighed according to a formula below:

10 g of spherical aluminum oxide, 5 g of epoxy resin EPALLOY 8220, 8 g of cyanate ester resin CEO5CS, 0.4 g of cyanoguanidine, 0.01 g of 2-methyl-4-ethyl imidazole, 0.3 g of nonylphenol polyoxyethylene ether, 10 g of N,N-dimethyl formamide and 10 g of butanone.

2. The components are subjected to ball-milling for 12 hours at 600 rpm to obtain electronic slurry of an insulating polymer composite.

3. The electronic slurry of the insulating polymer composite is coated to the surface of a PET thin film with a thickness of 50 μm by a comma scraper coating manner.

4. The thickness of the insulating polymer composite film is controlled according to a solid content of the electronic slurry and a separation distance between the scraper and the PET thin film, the thickness of the dried thin film is controlled to be 20 μm, the segmented oven is used in the drying process, the temperature of the oven is raised stage by stage, and started from the coating end, the temperature of the oven is set at 60° C., 80° C., 100° C., 110° C. and 120° C.

5. The dried insulating polymer composite film and the OPP film with the thickness of 20 μm are subjected to hot pressing compounding, and in the hot pressing process, a temperature of a heating roller is set at 70° C. Hot pressing is carried out to obtain the insulating coating material with the three-layered structure.

6. The glass transition temperature of the cured insulating coating material of Example 1 is 202° C.

### Example 2

1. The components are weighed according to a formula below:

10 g of spherical silicon dioxide, 2 g of epoxy resin HyPox PK 84, 10 g of epoxy resin NPES-902, 8 g of cyanate ester resin CEO5CS, 1 g of cyanoguanidine, 0.03 g of 2-methyl-4-ethyl imidazole, 0.3 g of nonylphenol polyoxyethylene ether, 10 g of N,N-dimethyl formamide and 20 g of butanone.

2. The components are subjected to ball-milling for 12 hours at 600 rpm to obtain electronic slurry of an insulating polymer composite.

3. The electronic slurry of the insulating polymer composite is coated to the surface of a PET thin film with a thickness of 50 μm by a comma scraper coating manner.

4. The thickness of the insulating polymer composite film is controlled according to a solid content of the electronic slurry and a separation distance between the scraper and the PET thin film, the thickness of the dried thin film is controlled to be 20 μm, the segmented oven is used in the drying process, the temperature of the oven is raised stage by stage, and started from the coating end, the temperature of the oven is set at 60° C., 80° C., 100° C., 110° C. and 120° C.

5. The dried insulating polymer composite film and the OPP film with the thickness of 20 μm are subjected to hot pressing compounding, and in the hot pressing process, a temperature of a heating roller is set at 70° C. Hot pressing is carried out to obtain the insulating coating material with the three-layered structure.

6. The glass transition temperature of the cured insulating coating material of Example 2 is 185° C.

### Example 3

1. The components are weighed according to a formula below: 10 g of spherical silicon dioxide, 2 g of epoxy resin HyPox PK 84, 15 g of epoxy resin NPES-902, 5 g of cyanate ester resin CEO5CS, 1 g of cyanoguanidine, 0.03 g of 2-methyl-4-ethyl imidazole, 0.3 g of nonylphenol polyoxyethylene ether, 10 g of N,N-dimethyl formamide and 20 g of butanone.

2. The components are subjected to ball-milling for 12 hours at 600 rpm to obtain electronic slurry of an insulating polymer composite.

3. The electronic slurry of the insulating polymer composite is coated to the surface of a PET thin film with a thickness of 50 μm by a comma scraper coating manner.

4. The thickness of the insulating polymer composite film is controlled according to a solid content of the electronic slurry and a separation distance between the scraper and the PET thin film, the thickness of the dried thin film is controlled to be 20 μm, the segmented oven is used in the drying process, the temperature of the oven is raised stage by stage, and started from the coating end, the temperature of the oven is set at 60° C., 80° C., 100° C., 110° C. and 120° C.

5. The dried insulating polymer composite film and the OPP film with a thickness of 20 μm are subjected to hot pressing compounding, and in the hot pressing process, a temperature of a heating roller is set at 70° C. Hot pressing is carried out to obtain the insulating coating material with the three-layered structure.

6. The glass transition temperature of the cured insulating coating material of Example 3 is 165° C.

### Comparative Example 4

1. The components are weighed according to a formula below: 10 g of spherical aluminum oxide, 13 g of epoxy resin EPALLOY 8220, 1 g of cyanoguanidine, 0.1 g of 2-methyl-4-ethyl imidazole, 0.3 g of nonylphenol polyoxyethylene ether, 10 g of N,N-dimethyl formamide and 10 g of butanone.

2. The components are subjected to ball-milling for 12 hours at 600 rpm to obtain electronic slurry of an insulating polymer composite.

3. The electronic slurry of the insulating polymer composite is coated to the surface of a PET thin film with the thickness of 50 μm by a comma scraper coating manner.

4. The thickness of the insulating polymer composite thin film is controlled according to a solid content of the electronic slurry and a separation distance between the scraper and the PET thin film, the thickness of the dried thin film is controlled to be 20 μm, the segmented oven is used in the drying process, the temperature of the oven is raised stage by stage, and started from the coating end, the temperature of the oven is set at 60° C., 80° C., 100° C., 110° C. and 120° C.

5. The dried insulating polymer composite film and the OPP film with the thickness of 20 μm are subjected to hot pressing compounding, and in the hot pressing process, a temperature of a heating roller is set at 70° C. Hot pressing is carried out to obtain the insulating coating material with the three-layered structure.

6. The glass transition temperature of the cured insulating coating material of Comparative example 4 is 105° C.

### Comparative Example 5

1. The Components are Weighed According to a Formula Below:

10 g of spherical silicon dioxide, 10 g of epoxy resin HyPox PK 84, 10 g of epoxy resin NPES-902, 1 g of cyanoguanidine, 0.3 g of 2-methyl-4-ethyl imidazole, 0.3 g of nonylphenol polyoxyethylene ether, 10 g of N,N-dimethyl formamide and 20 g of butanone.

2. The components are subjected to ball-milling for 12 hours at 600 rpm to obtain electronic slurry of an insulating polymer composite.

3. The electronic slurry of the insulating polymer composite is coated to the surface of a PET thin film with the thickness of 50 μm by a comma scraper coating manner.

4. The thickness of the insulating polymer composite thin film is controlled according to a solid content of the electronic slurry and a separation distance between the scraper and the PET thin film, the thickness of the dried thin film is controlled to be 20 μm, the segmented oven is used in the drying process, the temperature of the oven is raised stage by stage, and started from the coating end, the temperature of the oven is set at 60° C., 80° C., 100° C., 110° C. and 120° C.

5. The dried insulating polymer composite film and the OPP film with the thickness of 20 μm are subjected to hot pressing compounding, and in the hot pressing process, a temperature of a heating roller is set at 70° C. Hot pressing is carried out to obtain the insulating coating material with the three-layered structure.

6. The glass transition temperature of the cured insulating coating material of Comparative example 5 is 115° C.

### Comparative Example 6

1. The components are weighed according to a formula below: 10 g of spherical silicon dioxide, 7 g of epoxy resin HyPox PK 84, 15 g of epoxy resin NPES-902, 1 g of cyanoguanidine, 0.03 g of 2-methyl-4-ethyl imidazole, 0.3 g of nonylphenol polyoxyethylene ether, 10 g of N,N-dimethyl formamide and 20 g of butanone.

2. The components are subjected to ball-milling for 12 hours at 600 rpm to obtain electronic slurry of an insulating polymer composite.

3. The electronic slurry of the insulating polymer composite is coated to the surface of a PET thin film with the thickness of 50 μm by a comma scraper coating manner.

4. The thickness of the insulating polymer composite thin film is controlled according to a solid content of the electronic slurry and a separation distance between the scraper and the PET thin film, the thickness of the dried thin film is controlled at 20 μm, the segmented oven is used in the drying process, the temperature of the oven is raised stage by stage, and started from the coating end, the temperature of the oven is set at 60° C., 80° C., 100° C., 110° C. and 120° C.

5. The dried insulating polymer composite thin film and the OPP thin film with the thickness of 20 μm are subjected to hot pressing compounding, and in the hot pressing process, a temperature of a heating roller is set at 70° C. Hot pressing is carried out to obtain the insulating coating material with the three-layered structure.

6. The glass transition temperature of the cured insulating coating material of Comparative example 6 is 115° C.

What is claimed is:

1. A high-temperature-resistant insulating polymer composite, wherein the high-temperature-resistant insulating polymer composite is prepared from the following raw materials in parts by mass: 3-12 parts of a cyanate ester resin, 3-20 parts of an epoxy resin, 5-15 parts of an inorganic filler, 0.1-2 parts of an epoxy resin curing agent, 0.0001-0.005 parts of a curing accelerant, and 0.1-2 parts of a first dispersant.

2. The high-temperature-resistant insulating polymer composite according to claim 1, wherein a mass of the cyanate ester resin accounts for 5%-85% of a total mass of the cyanate ester resin and the epoxy resin.

3. The high-temperature-resistant insulating polymer composite according to claim 1, wherein a glass transition temperature of the high-temperature-resistant insulating polymer composite is higher than 120° C.

4. The high-temperature-resistant insulating polymer composite according to claim 1, wherein the high-temperature-resistant insulating polymer composite is a laminate with a thickness of 1 μm to 300 μm.

5. The high-temperature-resistant insulating polymer composite according to claim 1, wherein the cyanate ester resin is at least one selected from the group consisting of bisphenol A cyanate ester, bisphenol F cyanate ester, bisphenol E cyanate ester, bisphenol M cyanate ester, dicyclopentadiene cyanate ester, phenolic cyanate ester, and tetramethyl bisphenol F cyanate ester;
, the epoxy resin is selected from the group consisting of bisphenol A epoxy resin, bisphenol F epoxy resin, phenolic epoxy resin, o-methyl phenolic epoxy resin, polyfunctional epoxy resin, alicyclic epoxy resin, resorcinol epoxy resin, rubber modified epoxy resin, polyurethane modified epoxy resin, biphenyl epoxy resin, and brominated epoxy resin;
, the epoxy resin curing agent is selected from the group consisting of a fatty polyamine curing agent, an alicyclic polyamine curing agent, an aromatic amine curing agent, an anhydride curing agent, a polyamide curing agent, a latent curing agent, and a synthetic resin curing agent, and, the latent curing agent is selected from the group consisting of cyanoguanidine, boron trifluoride monoethylamine, boron trifluoride phenylethylamine, boron trifluoride o-toluidine, boron trifluoride bianamine, boron trifluoride dimethylaniline, boron trifluoride ethylaniline, boron trifluoride pyridine, an MS-1 microcapsule, an MS-2 microcapsule, and triacylhydrazine maleate;
the curing accelerant is at least one selected from the group consisting of an imidazole epoxy resin curing accelerant, phenol, bisphenol A, resorcinol, 2,4,6-tri (dimethylamino methylene) phenol, benzyl dimethylamine, acyl guanidine, benzoyl peroxide, copper acetylacetone, aluminum acetylacetonate, and zirconium acetylacetonate;
, the inorganic filler is at least one selected from the group consisting of silicon dioxide, aluminum oxide, boron nitride, titanium dioxide, zinc oxide, zirconium oxide, magnesium oxide, calcium carbonate, barium titanate, strontium titanate, barium strontium titanate, lead zirconate titanate, and calcium copper titanate;
dimensions of inorganic filler particles are 20 nm-10 μm or the inorganic filler particles are a multi-scale mixture;
the inorganic filler particles are selected from the group consisting of spherical particles, spheroidal particles, rodlike particles, linear particles, and flaky particles;
the inorganic filler particles account for 20%-80% by mass of solid components of the high-temperature-resistant insulating polymer composite, the solid components of the high-temperature-resistant insulating polymer composite are nonvolatile;
the first dispersant is selected from the group consisting of an anionic emulsifier, a cationic emulsifier, and a non-ionic emulsifier,
and the non-ionic emulsifier is selected from the group consisting of nonylphenol polyoxyethylene ether, alkyl phenol polyoxyethylene ether, high-carbon fatty alcohol polyoxyethylene ether, fatty acid polyoxyethylene ether, fatty acid methyl ester ethoxylate, and a high-molecular polymer; the anionic emulsifier is selected from the group consisting of cis-9-sodium octadecenoate, sodium oleate, sodium oleate, sodium laurate, C13-C18 sodium alkyl benzene sulfinate; and sulfate; and the cationic emulsifier is an alkyl ammonium salt emulsifier, the alkyl ammonium salt emulsifier is at least one selected from the group consisting of dodecyl ammonium chloride and a quaternary ammonium salt, and the quaternary ammonium salt is cetyl trimethyl ammonium bromide and cetyl brominated pyridine pyran.

6. The high-temperature-resistant insulating polymer composite according to claim 1, wherein the high-temperature-resistant insulating polymer composite is obtained by mixing the raw materials with a solvent to prepare an electronic slurry and then drying the electronic slurry when the high-temperature-resistant insulating polymer composite is prepared, wherein the solvent used is a volatile solvent selected from the group consisting of an aromatic solvent, a halogenated hydrocarbon solvent, a fatty hydrocarbon solvent, an alicyclic hydrocarbon solvent, an alcohol solvent, an ester solvent, a ketone solvent, and an amide solvent.

7. The high-temperature-resistant insulating polymer composite according to claim 1, further comprising an auxiliary agent, wherein the auxiliary agent is at least one selected from the group consisting of a second dispersant, a defoamer, a coupling agent, an anti-settling agent, a leveling agent, a rheological agent, and a flame retardant.

8. A preparation method of the high-temperature-resistant insulating polymer composite according to claim 1, comprising steps of:
1) uniformly dispersing the cyanate ester resin, the epoxy resin, the inorganic filler, the epoxy resin curing agent, the curing accelerant, the dispersant, and a solvent to obtain an electronic slurry of the high-temperature-resistant insulating polymer composite; and
2) coating the electronic slurry of the high-temperature-resistant insulating polymer composite to a surface of a film material layer, attaching the electronic slurry of the high-temperature-resistant insulating polymer composite to a protective film layer after being dried by an oven to form an insulating coating material;
wherein, a coating mode of the electronic slurry of the high-temperature-resistant insulating polymer composite is selected from the group consisting of gravure printing, micro-gravure printing, comma scrapers, and slit extrusion, and a drying temperature of the solvent is 50° C.-150° C., and, drying is a sectional temperature rise baking.

9. A method of preparing a high-temperature-resistant insulating coating material, comprising a step of using the high-temperature-resistant insulating polymer composite according to claim 1 in preparing the high-temperature-resistant insulating coating material.

10. A high-temperature-resistant insulating coating material, wherein the high-temperature-resistant insulating coating material is a three-layered structure composed of a protective film layer, a layer of the high-temperature-resistant insulating polymer composite according to claim L and a film material layer, wherein the layer of the high-temperature-resistant insulating polymer composite is supported by the film material layer, and a surface of the layer of the high-temperature-resistant insulating polymer composite is covered with the protective film layer;
the film material layer is a first polymer film material or a paper-based film material, the first polymer film material is selected from the group consisting of a polyester (PET) film, a polyether-ether-ketone (PEEK) film, a polyetherimide (PEI) film, a polyimide (PI) film, and a polycarbonate (PC) film, and the paper-based film material is selected from the group consisting of a release paper and a coated paper;
a thickness of the film material layer is 10 μm-300 μm;
the layer of the high-temperature-resistant insulating polymer composite is formed by an electronic slurry of the high-temperature-resistant insulating polymer composite and on a surface of the film material layer;
a material of the protective film layer is second polymer film material, and the second polymer film material is selected from the group consisting of a polyester film, a polypropylene film, and a polyethylene film;
a thickness of the protective film layer is 10 μm-300 μm;
a thickness of the layer of the high-temperature-resistant insulating polymer composite between the film material layer and the protective film layer is 1 μm-100 μm.

11. A preparation method of the high-temperature-resistant insulating coating material according to claim 10, comprising steps of:
1) uniformly dispersing the cyanate ester resin, the epoxy resin, the inorganic filler, the aepoxy resin curing agent, the curing accelerant, the dispersant, and a solvent to form the electronic slurry of the high-temperature-resistant insulating polymer composite; and
2) coating the electronic slurry of the high-temperature-resistant insulating polymer composite to the surface of the film material layer, attaching the electronic slurry of the high-temperature-resistant insulating polymer composite to the protective film layer after being dried by an oven to form the high-temperature-resistant insulating coating material;
wherein a coating mode of the electronic slurry of the high-temperature-resistant insulating polymer composite is selected from the group consisting of gravure printing, micro-gravure printing, comma scrapers, and slit extrusion, a drying temperature of the solvent is 50° C.−150° C., and drying is a sectional temperature rise baking;
after the solvent is baked and dried, attaching the protective film layer and obtaining the high-temperature-resistant insulating coating material with the three-layered structure in a hot-pressing mode at a temperature of 50° C.-100° C.

12. A method of preparing a semiconductor electronic package, comprising a step of using the high-temperature-resistant insulating coating material according to claim 10 for the semiconductor electronic package, wherein the semiconductor electronic package is a fine circuit package or a package of a printed circuit board, a substrate and a carrier board made by an addition process or a semi-addition process.

13. The high-temperature-resistant insulating polymer composite according to claim 6, wherein
the aromatic solvent is selected from the group consisting of xylene, o-xylene, m-xylene, p-xylene, hexamethyl benzene, and ethylbenzene;
the halogenated hydrocarbon solvent is selected from the group consisting of chlorobenzene, dichlorobenzene, and dichloromethane;
the fatty hydrocarbon solvent is selected from the group consisting of pentane, pentane, and pentane;
the alicyclic hydrocarbon solvent is selected from the group consisting of cyclohexane, cyclohexanone, and toluene cyclohexanone;
the alcohol solvent is selected from the group consisting of methanol, ethanol, and isopropanol;
the ester solvent is selected from the group consisting of methyl acetate, acetic ether, and propyl acetate;
the ketone solvent is selected from the group consisting of acetone, 2-butanone, and methyl isobutyl ketone; and
the amide solvent is at least one selected from the group consisting of dimethylformamide, hexamethyl phosphamide, N-methyl formamide, and dimethylacetamide.

14. The preparation method according to claim 8, wherein in step 1), an auxiliary agent is further added to obtain the electronic slurry of the high-temperature-resistant insulating polymer composite, and the auxiliary agent is selected from the group consisting of a second defoamer, a coupling agent, an anti-settling agent, a leveling agent, a rheological agent, and a flame retardant.

15. The preparation method according to claim 11, wherein in step 1), an auxiliary agent is further added to form the electronic slurry of the high-temperature-resistant insulating polymer composite, wherein the auxiliary agent is selected from the group consisting of a second defoamer, a coupling agent, an anti-settling agent, a leveling agent, a rheological agent, and a flame retardant.
